(19) United States
(12) Patent Application Publication
(10) Pub. No.: US 2020/0103104 A1
(43) Pub. Date: Apr. 2, 2020

(54) LED Lighting Fixture

(71) Applicant: Brightline, Inc., Bridgeville, PA (US)

(72) Inventors: Samuel P. Cercone, Aliquippa, PA (US); Ryan J. Cercone, Pittsburgh, PA (US)

(21) Appl. No.: 16/582,296

(22) Filed: Sep. 25, 2019

Related U.S. Application Data
(60) Provisional application No. 62/737,417, filed on Sep. 27, 2018.

(51) Int. Cl. F21V 29/76; F21V 29/503; F21V 15/015; F21V 23/00; F21V 29/508

(52) U.S. Cl. CPC F21V 29/763; F21V 29/503; F21Y 2115/10; F21V 23/003; F21V 29/508; F21V 15/015

(57) ABSTRACT

An elongated LED lighting fixture includes a heat sink assembly having a base and a pair of heat sinks extending from either side of the base in a direction opposite a bottom side of the base. The base and the pair of heat sinks define a slot opposite the bottom side of the base. A top cover covers the slot. A LED strip is disposed on the bottom side of the base opposite the slot. A bottom cover includes an opening between a pair of curved sides. A pair of fins is disposed between the curved sides opposite the opening and the bottom side of the base of heat sink assembly. An outline of a cross-section of the elongated LED lighting fixture defines spaced rounded sides extending between a planar top and a planar bottom. In cross-section, the LED lighting fixture has a generally or substantially oval shape.

### CROSS-REFERENCE TO RELATED APPLICATION

This application claims the benefit of U.S. Provisional Patent Application No. 62/737,417, filed Sep. 27, 2018, the contents of which are incorporated herein in their entirety.

### BACKGROUND OF THE INVENTION

### Field of the Invention

The present invention generally relates to LED lighting fixtures and, in particular, a LED lighting fixture having a generally oval shaped cross-section.

### Description of Related Art

Heretofore, the shapes of elongated LED lighting fixtures were derived from or based on the shapes of elongated fluorescent lighting fixtures having sides that extended laterally outward and in some instances were positioned at a right angles to at least a bottom of the lighting fixture, giving the lighting fixture, when viewed from an end thereof, a square shape that required additional space for mounting the lighting fixture. The shapes of these prior art elongated LED and fluorescent lighting fixtures are considered by some to aesthetically unappealing.

Moreover, there is a need for improved heat dissipation in elongated LED lighting fixtures over elongated fluorescent lighting fixtures, wherein the fluorescent bulb(s) themselves were generally capable, in most instances, of dissipating heat generated during use.

### SUMMARY OF THE INVENTION

Generally, provided, in some non-limiting embodiments or examples, is an LED lighting fixture. Further non-limiting embodiments or examples are set forth in the following numbered clauses.

Clause 1: An elongated LED lighting fixture comprises: a heat sink assembly including a base and a pair of heat sinks extending from either side of the base in a direction opposite a bottom side of the base, wherein the base and the pair of heat sinks define a slot opposite the bottom side of the base; a top cover covering the slot; an LED strip disposed on the bottom side of the base of heat sink assembly opposite the slot; a bottom cover including an opening between a pair of curved sides; and a pair of fins disposed between the curved sides opposite the opening and the bottom side of the base of heat sink assembly.

Clause 2: The LED lighting fixture of clause 1, wherein an outline of a cross-section of the elongated LED lighting fixture can define spaced and generally or substantially rounded sides extending between a planar top and a planar bottom.

Clause 3: The LED lighting fixture of clause 1 or 2, wherein, in cross-section, the LED lighting fixture can have a generally or substantially oval shape.

Clause 4: The LED lighting fixture of any one of clauses 1-3, wherein each heat sink can include a plurality of spaced fins that extend in a direction opposite the bottom side of the base.

Clause 5: The LED lighting fixture of any one of clauses 1-4, with increasing lateral distance away from a vertical axis of the LED lighting fixture, tops of the fins are at an increasing vertical distance away from a plane defined by a top side of the top cover.

Clause 6: The LED lighting fixture of any one of clauses 1-5, wherein the LED lighting fixture can include an LED driver disposed in the slot.

Clause 7: The LED lighting fixture of any one of clauses 1-6, wherein the LED lighting fixture can include an LED driver disposed on a side of the top cover opposite the slot.

### BRIEF DESCRIPTION OF THE DRAWINGS

These and other features of the present invention will become more apparent from the following description wherein reference is made to the appended drawings wherein:

FIGS. 1-3 are respective perspective, top, and bottom views of one preferred and non-limiting embodiment or example LED lighting fixture in accordance with principles of the present invention;

FIG. 4 is an exploded perspective view of the LED lighting fixture of FIGS. 1-3;

FIG. 5A is a cross-section taken along lines V-V in FIG. 1;

FIG. 5B is an outline of the cross-section shown in FIG. 5A, wherein the lines forming the rounded sides of the cross-section run between the tops of the fins of the LED lighting fixture to illustrate that the sides of the LED lighting fixture have a rounded appearance;

FIG. 5C is another cross-section taken along lines V-V in FIG. 1; and

FIG. 6 is a cross-section taken along lines VI-VI in FIG. 1.

### DESCRIPTION OF THE INVENTION

Various non-limiting examples will now be described with reference to the accompanying figures where like reference numbers correspond to like or functionally equivalent elements.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the example(s) as oriented in the drawing figures. However, it is to be understood that the example(s) may assume various alternative variations and step sequences, except where expressly specified to the contrary. It is also to be understood that the specific example(s) illustrated in the attached drawings, and described in the following specification, are simply exemplary examples or aspects of the invention. Hence, the specific examples or aspects disclosed herein are not to be construed as limiting.

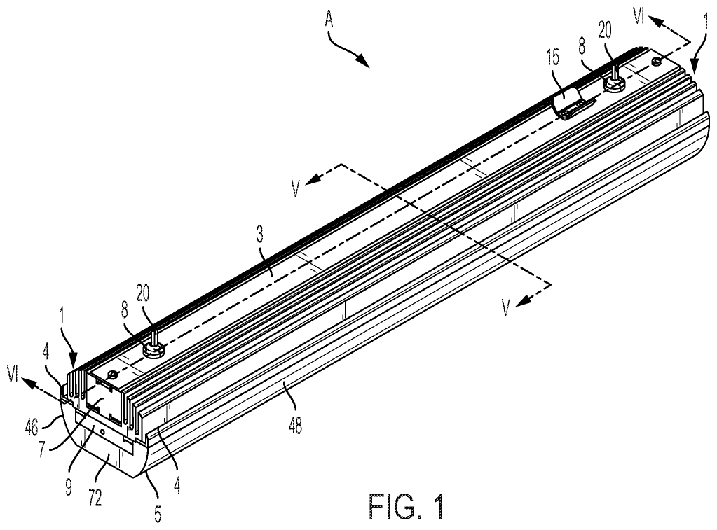

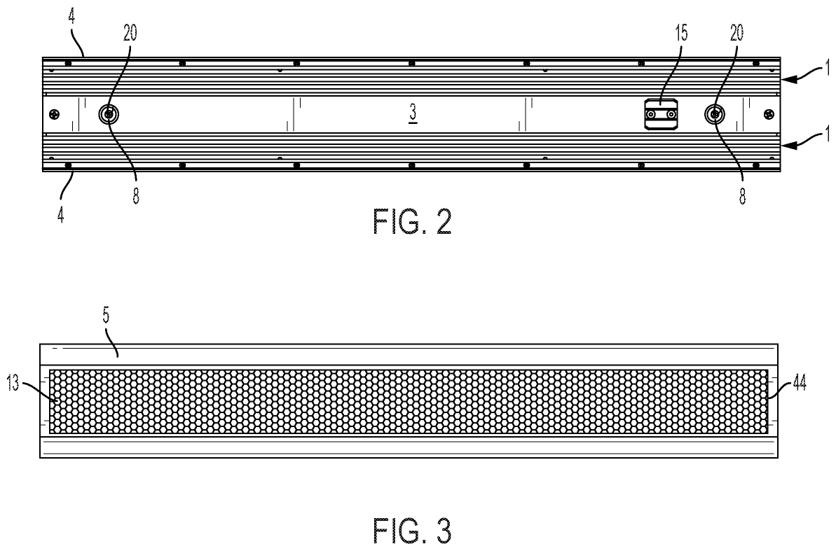

FIGS. 1-3 are perspective, top, and bottom views, respectively, of one preferred and non-limiting embodiment or example LED lighting fixture A in accordance with principles of the present invention. The LED lighting fixture includes an elongated heat sink assembly 1 and a top cover 3 positioned on top of heat sink assembly 1. On opposite sides of heat sink assembly 1 are positioned fins 4 which are held to heat sink assembly 1 by a bottom cover 5.

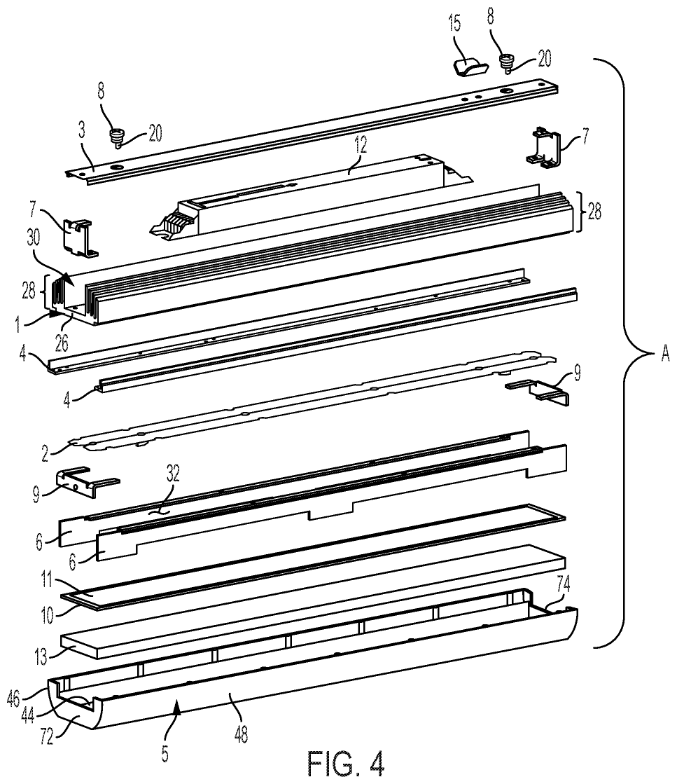

With reference to FIG. 4 and with continuing reference to FIGS. 1-3, end covers 7 are positioned on opposite ends of heat sink assembly 1. Bushings 8 are positioned proximate opposite ends of top cover 3 for supporting electrical cords 20 for delivery of electricity to LEDs mounted on a LED strip 2 or to an optional LED driver 12 (described hereinafter) which can be disposed within a slot/channel 30 defined by a heat sink assembly 1, top cover 3, and end covers 7.

LED mounting brackets 9 are positioned on opposite ends of the LED lighting fixture between heat sink assembly 1 and bottom cover 5 for supporting LED strip 2 within a space 32 defined by a pair screen/diffuser risers 6, bottom cover 5, and a filter 13. In particular, the pair of LED mounting brackets 9 is coupled to opposite ends of the bottom of base 26 via suitable fasteners and aid in supporting the ends of LED strip 2 against the bottom of base 26.

Finally, the LED lighting fixture can include filter 13 for filtering light output by LEDs of LED strip 2. In an example, filter 13 can be a collimator that can be used with an optional gel assembly 10 (including diffusing gel 11) for collimating and, optionally, diffusing light output by the LEDs of LED strip 2. In another example, filter 13 can be light diffuser that can be used without gel assembly 10 for diffusing light output by the LEDs of LED strip 2.

As shown in FIG. 4, heat sink assembly 1 includes an elongated base 26 having a pair of elongated heat sinks 28 extending upward from either side of base 26 and defining therebetween an elongated slot or channel 30. Optional LED driver 12 can be positioned on base 26 in slot or channel 30 between the pair of heat sinks 28. End covers 7 can be positioned on opposite ends of slot or channel 30, and top cover 3 can be positioned on top of LED driver 12 and can extend between end covers 7 and the pair of heat sinks 28 in the final assembly of the LED lighting fixture. In an example, LED driver 12 can be optional because power can be provided directly to the LEDs of LED strip 2 via one or both electrical cords 20. In another example, 4 electrical power can be provided via one or both electrical cords 20 to LED driver 12 which can, in-turn, supply conditioned electrical power to the LEDs mounted on LED strip 2.

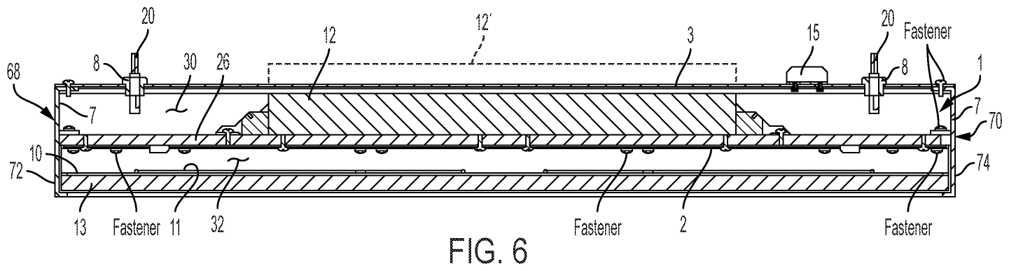

In this description, it is to be understood that the various elements described herein are held together by suitable fasteners, only some of which are shown herein for the purpose of simplicity. FIG. 6 shows some example fasteners and their locations. However, this is not to be construed in a limiting sense.

LED strip 2 is mounted to (in contact with) the bottom or underside of base 26 of heat sink assembly 1 with the LED's thereof (not numbered) facing downward. Also mounted to the bottom of heat sink assembly 1 on opposite sides of base 26 are elongated fins 4 which extend upwardly along the exterior sides of heat sinks 28 on opposite sides of heat sink assembly 1.

The pair of screen/diffuser risers 6 is coupled in spaced relation to the bottom or underside of base 26 of heat sink assembly 1 via suitable fasteners which also aid in securing opposite sides of LED strip 2 to the bottom of base 26. The pair of screen/diffuser risers 6 coupled to base 26, together with filter 13, define space 32 therebetween.

In FIG. 4, LED strip 2 is coupled between the bottom of base 26 and the tops of screen/diffuser risers 6. Optional gel assembly 10, including diffusing gel 11, can be positioned in space 32 proximate the bottom of the pair of screen diffuser/risers 6. Gel assembly 10, also known as a gel panel, can be provided to diffuse and filter light output by the LEDs of LED strip 2 in a manner known in the art. Gel assembly 10 can be used in combination with a filter 13 in the nature of a collimator. In an example, gel assembly 10, including diffusing gel 11, may be omitted when filter 13 also or alternatively performs a light diffusing function.

On the side of gel assembly 10 opposite LED strip 2 is positioned filter 13. In one preferred and non-limiting embodiment or example, filter 13 can be in the nature of a collimator having honeycomb shaped cells as shown best in FIG. 3. However, this is not to be construed in a limiting sense since each cell of filter 13 in the nature of a collimator can have any shape deemed suitable and/or desirable.

Finally, bottom cover 5 is mounted to the bottom of base 26 via fins 4 enclosing LED strip 2, screen/diffuser risers 6, optional gel assembly 10, and filter 13.

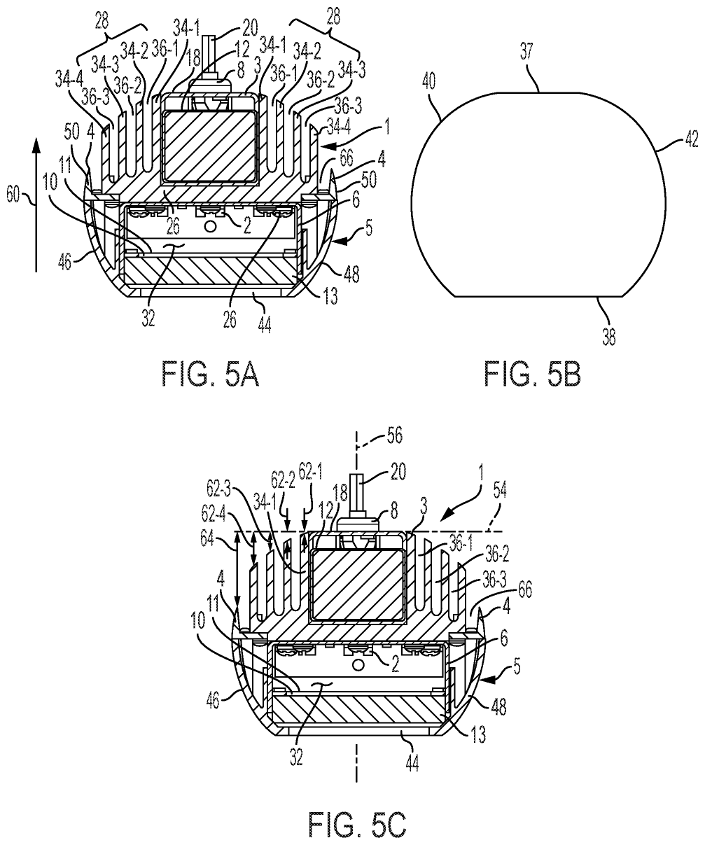

Reference will now be made to FIGS. 5A and 5C which are cross-sections taken along lines V-V in FIG. 1.

As shown in FIGS. 5A and 5C, each heat sink 28 includes a plurality of elongated fins 34 that extend upward from base 26 on opposite sides of slot/channel 30. In one preferred and non-limiting embodiment or example, each heat sink 28 can include a first fin 34-1 having one side that defines a side of slot/channel 30 that can be in contact with a side of LED driver 12 when provided. In an example, the fins 34 of heat sink 28 can include fins 34-1, 34-2, 34-3, and 34-4 spaced from each other by gaps 36-1, 36-3, and 36-3.

As can be understood from FIGS. 5A and 5B, the latter of which (FIG. 5B) is an isolated outline of the cross-section shown in FIG. 5A, the outline of the cross-section of the LED lighting fixture defines a planar top 37, defined by a top surface 18 of top cover 3, a planar bottom 38, defined by the bottom of cover 5, which includes an elongated opening 44 for light to exit the LED lighting fixture, and a pair of rounded sides 40 and 42 that extend between planar top 37 and planar bottom 38. The isolated outline of the cross-section shown in FIG. 5A has a generally oval shape.

As can be understood from FIGS. 5A-5B, rounded sides 40 and 42 are defined by curved exterior sides 46 and 48 of bottom cover 5, the curved exterior sides 50 of each fin 4, and the tops 52 of each fin 34. In one preferred and non-limiting embodiment or example, each top 52 can be straight or can have the curvature or angle shown in FIG. 5A. Planar bottom 38 can be defined by a line extending laterally between the sides of bottom cover across elongated opening 44.

As can be seen in FIG. 5A, the tops of fins 34-1 are approximately the same height as the top surface 18 of top cover 3. The tops of fins 34-2 terminate at a height lower than the tops of fins 34-1. Similarly, the tops of fins 34-3 terminate at a height that is lower than the tops of fins 34-2. Finally, the tops of fins 34-4 terminate at a height that is lower than the tops of fins 34-3. In FIG. 5A, height is in the direction shown by arrow 60.

Referring to FIG. 5C, which is a copy of FIG. 5A including additional reference numbers, it can be seen when moving to the left of a vertical axis 56, the vertical distance between the top of each fin 34 and a lateral extension line or plane 54 of the top 18 of top cover 3 increases with increasing distance from vertical axis 56. For example, the distance between the top of fin 34-1 and line 54 is distance 62-1; the distance between the top of fin 34-2 and line 54 is distance 62-2; the distance between fin 34-3 and line 54 is distance 62-3; and the distance between the top of fin 34-4 and line 54 is distance 62-4. As can be seen in FIG. 5C, distance 62-4 is greater than distance 62-3 which is greater than distance 62-2 which is greater than distance 62-1, which can be zero. Also a distance between the top tip of each fin 4 and line 54 is distance 64 which is greater than distance 62-4. Similar comments apply in respect of the distance between line 54 and the top of each fin 34 and fin 4 on the right side of the cross-sectional view shown in FIG. 5C.

In one preferred and non-limiting embodiment or example, the vertical depth of each slot 36 between adjacent/proximate pairs of fins 34 can be the same or approximately the same. For example, the depths of slots 36-1, 36-2, and 36-3 can be the same or approximately the same. The vertical depth of slot 66 between each fin 34-4 and proximate fin 4 can be the same, less than, or greater than the depth of each slot 36.

The shape of heat sink assembly 1, top cover 3, fins 4, and bottom cover 5, when assembled as shown in FIG. 5C, can be symmetrical about vertical axis 56. The shape of fins 34 and fin 4 can be selected to provide the appearance of LED light fixture having a rounded outline/sides 40 and 42 as shown in FIG. 5B, i.e., when the tops of adjacent pairs of fins 34-1, 34-2, 34-3, 34-4, and fin 4 are connect by the lines forming or defining the rounded sides 40 and 42 shown in FIG. 5B. That is, the lines forming or defining rounded sides 40 and 42 in FIG. 5B connect the tops of fins 34-1, 34-2, 34-3, 34-4, and fin 4 giving sides 40 and 42 their rounded appearance.

The exterior sides of LED driver 12, when provided in slot/channel 30, can contact the interior sides of slots/channels 30 of heat sink assembly 1 to facilitate heat transfer from the electronics of LED driver 12 to heat sink assembly 1 and, more particularly, to the fins 34 of heat sink assembly 1.

With reference to FIG. 6, which is a cross-section taken along lines VI-VI in FIG. 1, as can be seen, LED driver 12, when provided, can be positioned in slot/channel 30 intermediate ends 68 and 70 of the LED lighting fixture. When provided, LED driver 12 can rest on a top side of base 26 of heat sink assembly 1. LED strip 2 can be secured to a bottom side of base 26 opposite slot/channel 30. Space 32 can separate LED strip 2 from gel assembly 10 which, when provided, can be positioned above and, optionally, in contact with filter 13.

FIG. 6 also shows an optional LED driver 12′ (shown in phantom line) which can be positioned on the top of top cover 3 and used when LED driver 12 is omitted. Via electrical power provided via one or more electrical cords 20, LED driver 12′ can be configured and connected to supply conditioned electrical power to the LEDs of LED strip 2.

Hence, as can be seen, lighting fixture A can include optional LED driver 12 received in slot/channel 30, or optional LED driver 12′ positioned on top of top cover 3, or no LED driver 12 or 12′, whereupon, in this latter case, electrical power can be provided directly to the LEDs of LED strip 2 from an external source of electrical power (not shown) via one or more electrical cords 20.

As can be see, disclosed herein is an elongated LED lighting fixture comprising a heat sink assembly 1 including a base 26 and a pair of heat sinks 28 extending from either side of the base 26 in a direction opposite a bottom side of base 26. The base 26 and the pair of heat sinks 28 define a slot 30 opposite the bottom side of base 26. A top cover 3 covers the slot 30. An LED strip 2 is disposed on the bottom side of the base 26 of heat sink assembly 1 opposite the slot 30. A bottom cover 5 includes an opening 44 between curved sides 46, 48 and ends 72, 74 of bottom cover 5. A pair of fins 4 is disposed between the curved sides 46, 48 opposite the opening 44 and the bottom side of the base 26 of heat sink assembly 1.

An outline of a cross-section of the elongated LED lighting fixture can define spaced rounded sides 40, 42 extending between a planar top 37 and a planar bottom 38. In cross-section, the LED lighting fixture can have a generally oval shape.

Each heat sink 28 can include a plurality of spaced fins 34 that extend in a direction opposite the bottom side of the base 26.

With increasing lateral distance away from a vertical axis 56 of the LED lighting fixture, tops of the fins 34 are at an increasing vertical distance 62 away from a lateral extension plane or line 54 of a top surface 18 of the top cover 3.

An LED driver 12 can be disposed in the slot 30. Alternatively, an LED driver 12′ can be disposed on a side of the top cover 3 opposite the slot 30.

As can be seen, the elongated LED lighting fixture disclosed herein is more compact than prior art LED lighting fixtures and has an aesthetically appealing appearance. The arrangement of the base 26 and heat sinks 28 facilitates the dissipation of heat generated during operation of the LED lighting fixture. In an example, the different distances 62-1-62-4 and 66 (FIG. 5C) between the lateral extension line or plane 54 and the tops of fins 34, 4 facilitate vertical heat flow away heat sink 28 during operation of the LED lighting fixture.

Although the invention has been described in detail for the purpose of illustration based on what is currently considered to be the most practical preferred and non-limiting embodiments, examples, or aspects, it is to be understood that such detail is solely for that purpose and that the invention is not limited to the disclosed preferred and non-limiting embodiments, examples, or aspects, but, on the contrary, is intended to cover modifications and equivalent arrangements that are within the spirit and scope of the appended claims. For example, it is to be understood that the present invention contemplates that, to the extent possible, one or more features of any preferred and non-limiting embodiment, example, or aspect can be combined with one or more features of any other preferred and non-limiting embodiment, example, or aspect.

The invention claimed is:

1. An elongated LED lighting fixture comprising:
a heat sink assembly including a base and a pair of heat sinks extending from either side of the base in a direction opposite a bottom side of base, wherein the base and the pair of heat sinks define a slot opposite the bottom side of base;
a top cover covering the slot;
an LED strip disposed on the bottom side of the base of heat sink assembly opposite the slot;
a bottom cover including an opening between a pair of curved sides; and
a pair of fins disposed between the curved sides opposite the opening and the bottom side of the base of heat sink assembly.

2. The LED lighting fixture of claim 1, wherein an outline of a cross-section of the elongated LED lighting fixture defines spaced rounded sides extending between a planar top and a planar bottom.

3. The LED lighting fixture of claim 2, wherein, in cross-section, the LED lighting fixture has an oval shape.

4. The LED lighting fixture of claim 1, wherein each heat sink includes a plurality of spaced fins that extend in a direction opposite the bottom side of the base.

5. The LED lighting fixture of claim 4, wherein, with increasing lateral distance away from a vertical axis of the LED lighting fixture, tops of the fins are at an increasing vertical distance away from a plane defined by a top side of the top cover.

6. The LED lighting fixture of claim 1, further including an LED driver disposed in the slot.

7. The LED lighting fixture of claim 1, further including an LED driver disposed on a side of the top cover opposite the slot.
